(19) United States
(12) Patent Application Publication
(10) Pub. No.: US 2003/0069984 A1
(43) Pub. Date: Apr. 10, 2003

(54) Computer access right intermediation support apparatus and job flow input method

(76) Inventor: Satoru Watanabe, Kokubunji (JP)

Correspondence Address: REED SMITH LLP, Suite 1400, 3110 Fairview Park Drive, Falls Church, VA, 22042, US

(21) Appl. No.: 10/213,066

(22) Filed: Aug. 7, 2002

(30) Foreign Application Priority Data
Oct. 10, 2001 (JP) P2001-312268

(51) Int. Cl. G06F 15/16; G06F 12/14; G06F 11/30; H04L 9/32

(52) U.S. Cl. 709/229; 713/200

(57) ABSTRACT

A job flow input means of a broker of the present invention displays (1) a display image format for inputting a job flow to an input/output apparatus, (2) icons of services (account job, stock management or the like) requested by a user depending on an input of the user thereof, (3) a communication route among respective icons, and (4) a communication cost of the route, while a restriction condition input means urges the user to input at least one restriction condition of the ASP computer access rights, a computer access right selection means searches a set of ASP computers for satisfying an input by the user from information about the computers stored in a service function storage means to obtain a communication cost of the same set of computers from a communication cost calculation means, and an output means sequentially outputs sets of the computers associated with the sets of ASP computer access rights with lower communication costs to the input/output apparatus. Thereby, a cost-effective intermediation is provided, based on the communication cost, for the user who requests incorporated software-based services consisting of a plurality of software-based services based upon the sets of ASP computer access rights.

### FIELD OF THE INVENTION

The present invention relates to a computer access right intermediation support apparatus for cost-effectively selecting a set of ASP computer access rights thereby providing various software-based services in which a plurality of services are incorporated into a job flow, and a job flow input method implemented by the same apparatus.

### BACKGROUND OF THE INVENTION

As a system for intermediating ASP computer access rights thereby providing various software-based services requested by users, the ASP Business Consortium and the Soft Bank Commerce Co., Ltd., for example, have proposed the Application Service Provider (“ASP”) intermediation systems.

These systems are capable of searching, from previously registered access rights of a computer, access rights of a computer which can provide various software-based services requested by users thereby assuring the provision of easier intermediation of the computer access rights to users who request a bundle of software-based services.

However, with the diversification of needs of the users in recent years, some users request the software-based services in which a plurality of services are incorporated into a job flow. A computer access right intermediation support method is required to cost-effectively select a set of ASP computer access rights for providing the incorporated software-based services.

As a technique for controlling cooperation of servers for providing the incorporated software-based services corresponding to the service requests from the users, the “Server Cooperation Control Method” is described in JP-B-170287/1997.

The cooperation of a plurality of servers can be realized corresponding to the requests by users with the method described in the above JP-B-170287/1997.

However, since the method of this prior art (JP-B-170287/1997) does not introduce a system in which users can cost-effectively designate the to-be-incorporated software-based services, this method is not suitable for intermediation of ASP computer access rights for the users who are requesting the incorporated services based on one job flow.

Moreover, the method described in the JP-A-15849/1999 does not select a cost-effective set of access rights from the sets of ASP computer access rights to execute the incorporated software-based services.

Therefore, the following problems arise with the method of the prior art when intermediation of ASP computer access rights is conducted for the users who are requesting the incorporated services within the job flow.

The first problem is that when a user has requested incorporation of a plurality of software-based services, it has to individually search many ASP computer access rights such that the number of steps required for intermediation increases and the intermediation of ASP computer access rights cannot be realized easily.

The second problem is that it is impossible to select a cost-effective set of ASP computer access rights considering the relevant communication cost among the ASP computers for executing the services cooperatively.

If the incorporated services are executed with two computers, data communication is conducted between these two computers which incurs communication cost owed to ISPs and the delay of data communication.

Since the transfer rate of an external network, such as the Internet, is slower than that of the internal network, such as an intra-office LAN (Local Area Network), if a couple of ASP computers used for executing the requests are located at difference areas, the communication cost and the delay of data communication increase remarkably.

Moreover, when the data communication is conducted via an external network, another type of communication cost is generated due to the encryption for keeping the secrecy of the communication data.

The third problem is how to satisfactorily input data required for the intermediation of ASP computer access rights by the users.

### SUMMARY OF THE INVENTION

The present invention has considered the problems explained above. It is an object of the present invention to easily assure intermediation of ASP computer access rights for the users who request the incorporated software-based services within a job flow by selecting a cost-effective set of the ASP computer access rights and moreover to easily input the information required for the intermediation of the ASP computer access rights.

To attain the objects explained above, the computer access right intermediation support apparatus of the present invention includes service function storage means for storing service functions supported by ASP computers of which access rights are sold and information regarding application service providers (ASPs) for supporting ASP computer access rights; job flow input means for displaying, on a display apparatus, a job flow requested by a user including a selection of service functions in the job flow from the stored service functions; ASP computer access right selection means for selecting at least one set of ASP computer access rights from the ASP computer access rights to provide the selected service functions by referring to ASPs and ASP computers associated with the selected set of ASP computer access rights; and output means for outputting the ASPs and the ASP computers associated with the selected set of ASP computer access rights.

According to another aspect of the invention, the method for intermediating ASP computer access rights between at least one user and a plurality of application service providers (ASPs) which support ASP computer access rights, includes the steps of: collecting and storing in a database service functions supported by the ASPs, ASP computers for executing the service functions, and locations of the ASP computers; receiving a job flow requested by the user which includes included service functions; searching the database to obtain a list of ASPs which support the at least one of the service functions in conjunction with ASP computers and ASP computer locations associated with the included service functions so as to compile candidate sets of ASP computer access rights for executing the included service functions in the job flow; calculating one corresponding communication cost for each of the candidate sets of ASP computer access rights; sorting the candidate sets of ASP computer access rights based upon the corresponding communication cost in a descending order; and providing the sorted results to the user to decide which one of the candidate sets of ASP computer access rights to use.

According to a more specific aspect of the invention, wherein the method for intermediating ASP computer access rights, the calculating step involves selecting any pair of ASP computers associated with the each candidate set of ASP computer access rights to repeat for each pair of ASP computers steps of: determining whether a communication is to be conducted between the pair of ASP computers to support the included service functions in the job flow; determining whether the locations of the pair of ASP computers are the same, if the communication is determined to be conducted therebetween; calculating a communication cost between the pair of ASP computers if the pair of ASP computers is determined as being located at two different locations, or assigning the communication cost between the pair of ASP computers as zero if the pair of ASP computers is determined as being located at a same location; and adding the communication cost between the pair of ASP computers or the zero into the corresponding communication cost for each of the candidate sets of ASP computer access rights.

According to a third aspect of the invention, the apparatus for intermediating ASP computer access rights between at least one user and a plurality of application service providers (ASPs) which support ASP computer access rights, includes a controller for: collecting and storing in a database service functions supported by the ASPs, ASP computers for executing the service functions, and locations of the ASP computers; receiving a job flow requested by the user which includes at least one of the service functions; searching the database to obtain a list of ASPs which support the included service functions in conjunction with ASP computers and ASP computer locations associated with the included service functions so as to compile candidate sets of ASP computer access rights for executing the included service functions in the job flow; calculating one corresponding communication cost for each of the candidate sets of ASP computer access rights; sorting the candidate sets of ASP computer access rights based upon the corresponding communication cost in a descending order; and providing the sorted results to the user to decide which one of the candidate sets of ASP computer access rights to use.

### BRIEF DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 shows a construction of an intermediation support system as an embodiment of the present invention.

FIG. 2 is a schematic diagram of an example of an actual computer system.

FIG. 3 shows a storage format of data registered to a service function storage means of the present invention.

FIG. 4 shows a display image format used when a job flow input means urges a user to input a job flow by utilizing a display unit of an input/output apparatus of the present invention.

FIG. 5 shows a pop-up window for inputting a communication cost.

FIG. 6 shows a pop-up window for inputting a communication quantity.

FIG. 7 shows a pop-up window with the restriction condition input means.

FIG. 8 is a flowchart of the process for selecting the computer access right according to the present invention.

FIG. 9 is a flowchart of the process for calculating a communication cost according to the present invention.

FIG. 10 is a table presented by an output means.

### DETAILED DESCRIPTION OF THE PREFERRED EMBODIMENTS

The preferred embodiments of the present invention are explained with reference to the accompanying drawings.

FIG. 1 is a construction diagram showing a construction of an intermediation support system as a preferred embodiment of the present invention.

A broker (an intermediation apparatus for cost-effectively selecting a set of ASP computer access rights) 103 is a computer comprising a calculation means and a storage means. A job flow input means 104, a restriction condition input means 105, an output means 106, a computer access right selection means 107, and a communication cost calculation means 108 are installed with a program stored in the storage device within the computer, while a service function storage means 109 is stored with data, and a data input/output program stored in the storage device of the computer.

In executing the computer access right intermediation support by utilizing the present invention, the data of available ASP computer access rights is stored in advance in the service function storage means 109.

An input/output apparatus 102 is composed of a keyboard, a mouse, a display and a printer or the like, and a user 101 can obtain information through the input to the job flow input means 104 and the restriction condition input means 105, and the output from the output means 106 by utilizing the input/output apparatus 102.

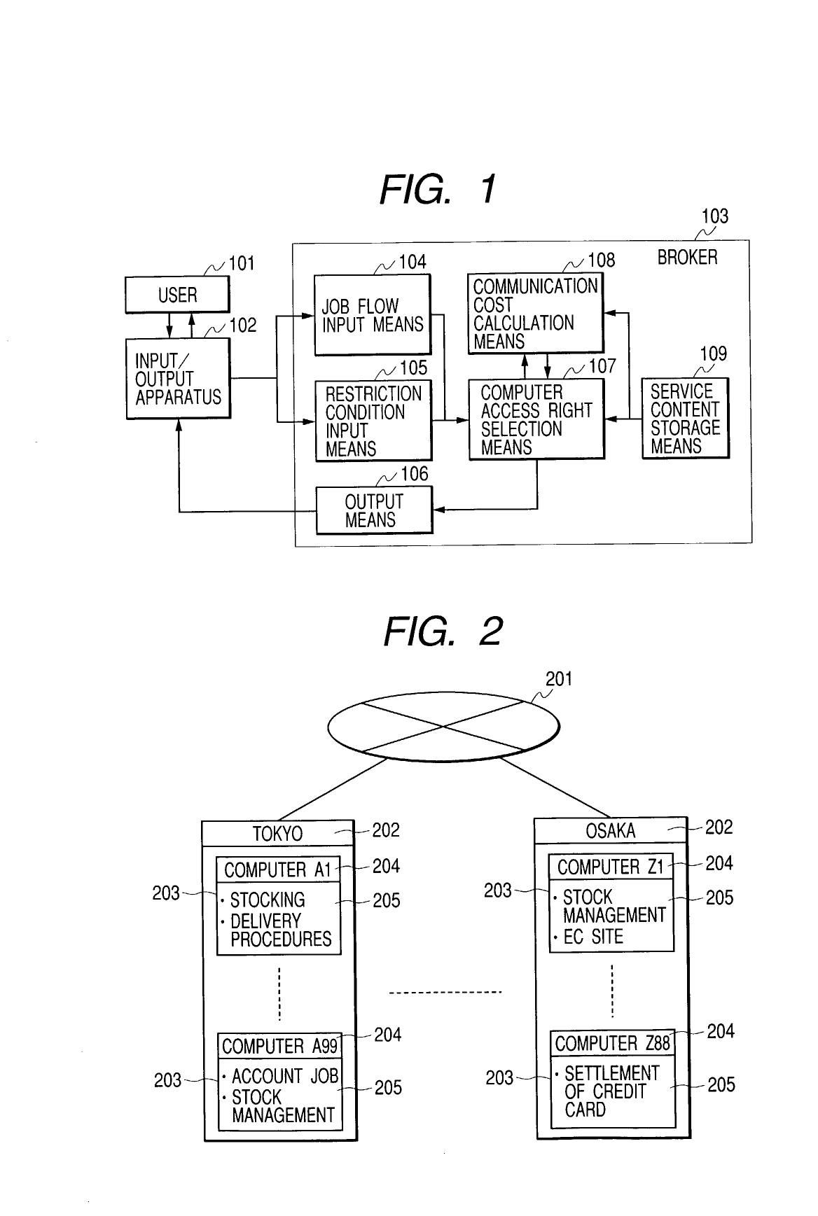

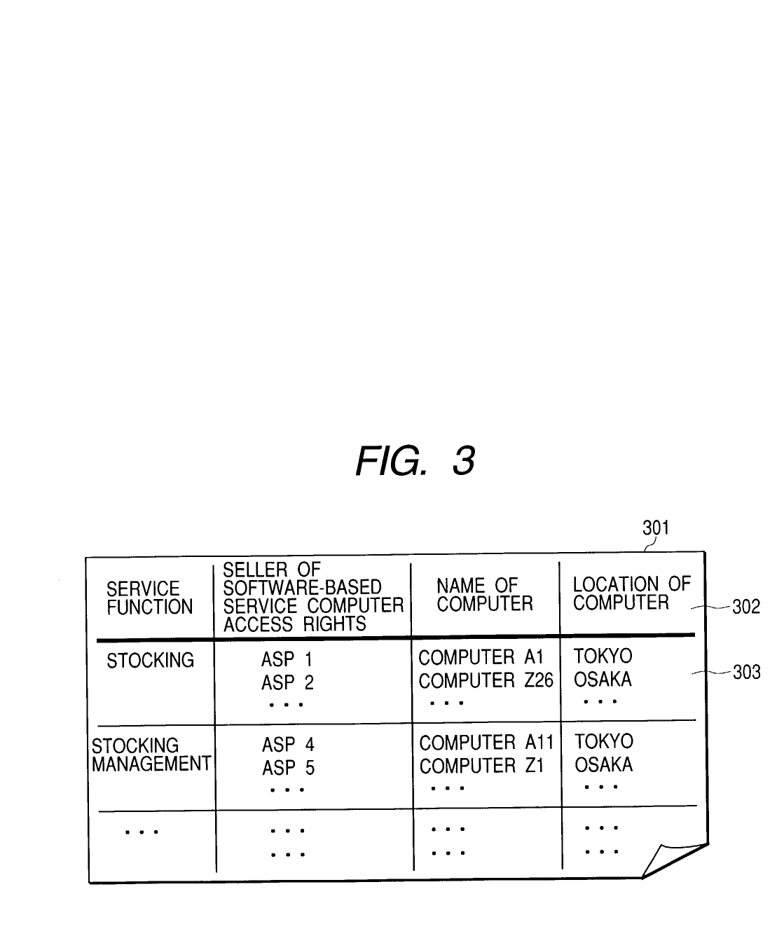

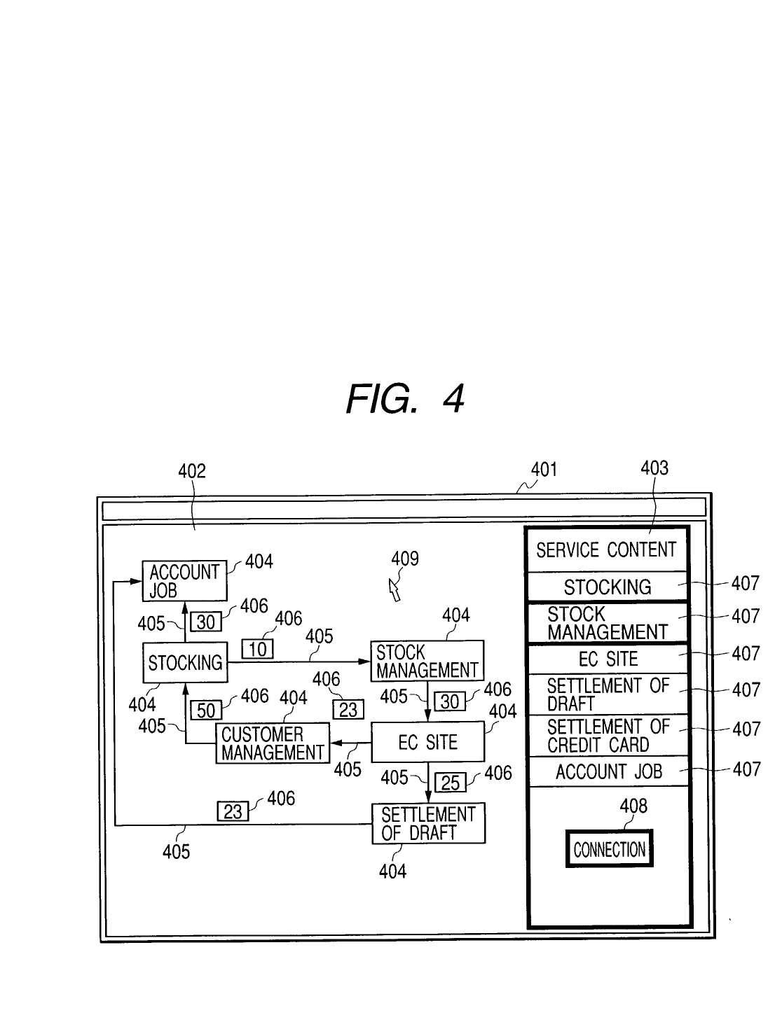

Next, the service function storage means 109 is explained with reference to FIG. 2 and FIG. 3.

FIG. 2 is a schematic diagram of an example of the actual computer system, where the computers 203 are available at the computer locations 202, such as Tokyo and Osaka.

The computers 203 are connected via a network 201 and each computer has a computer name 204.

For each of the computers 203, a service function 205 which may be executed using this computer is determined with a program or the like stored in the storage device of the computer.

To the service function storage means 109, the data of the computer location, the computer name 204, and the ASP of access rights of the computer are stored.

FIG. 3 shows a storage format of the data stored in the service function storage means 109.

The storage data 301 include a label portion 302 and a data portion 303, and each row of the data portion 303 indicates data of a bundle of computer access rights per one service function.

A computer location to be registered to the service function storage means 109 is not always required to be matched with the geographic computer location if it is more convenient for the intermediation of the computer access rights to register the computer locations of the computers in different geographical locations to the same location or to register the computer locations of the computers in the same geographical location to different locations.

Moreover, the service function storage means 109 is provided with a function to input and output the storage data loaded with a program.

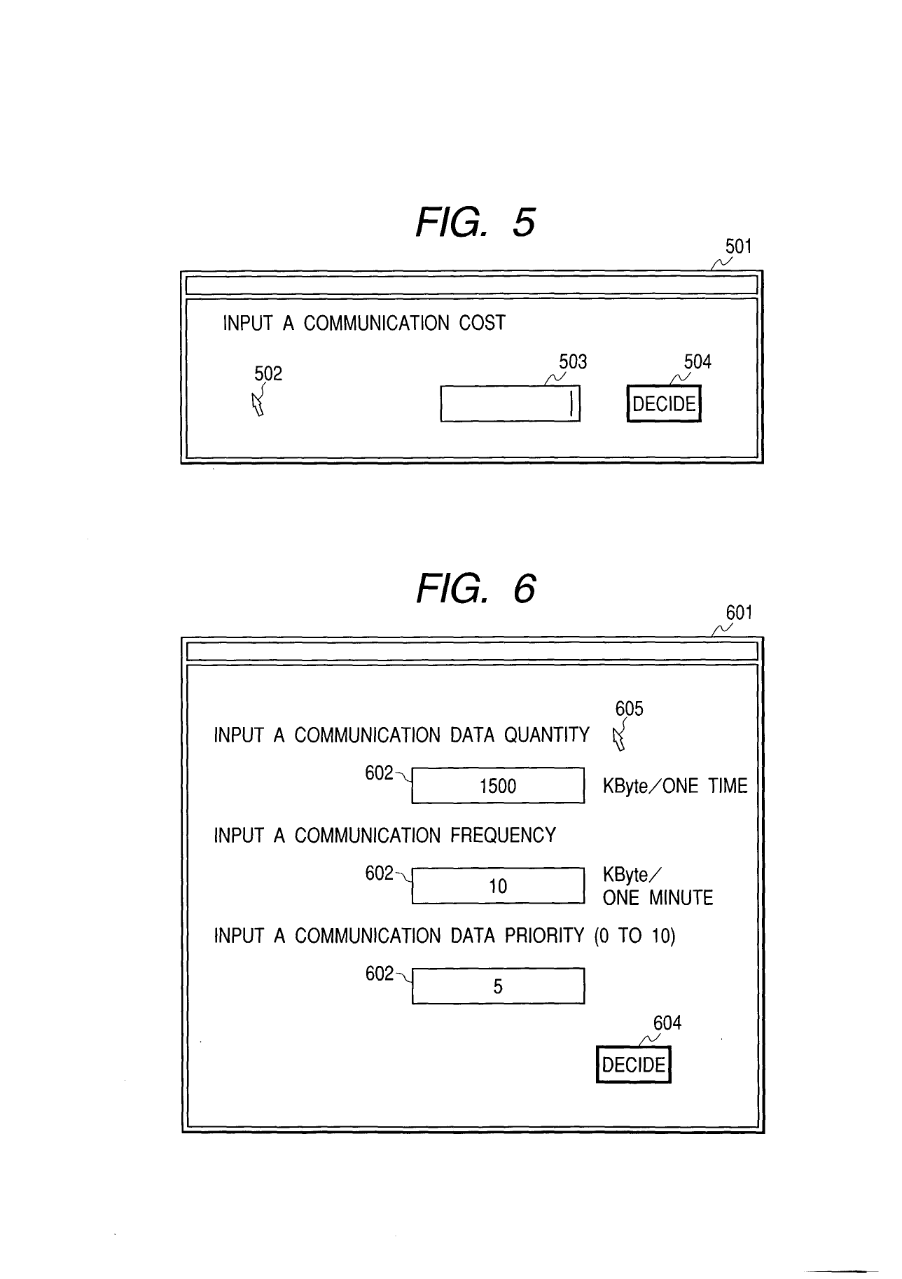

Next, the job flow input means 104 is explained with reference to FIG. 4, FIG. 5 and FIG. 6.

The job flow input means 104 urges a user to input a job flow by utilizing the input/output apparatus 102.

FIG. 4 shows a display image format with which the job flow input means 104 urges a user 101 to input a job flow by utilizing the display of the input/output apparatus 102.

The display image format 401 is composed of a job flow drawing area 402 and a function selection area 403.

A user 101 can input a job flow by controlling a pointer 409 on the display by manipulating a mouse of the input/output apparatus 102.

One of the service buttons 407 can be selected by setting the pointer 109 to click the respective area in the function selection area 403. Subsequently, a service icon 404 of the selected service button 407 is then drawn at the mouse click position within the block flow drawing area 402 and a job of the selected service button is inputted within the job flow.

A connection button 408 is selected by setting the pointer 409 to click the connection button 408 in the function selection area 403. Subsequently, a data communication arrow mark 405 is drawn to indicate the process flow of the job flow for each different service icon 404.

When it is inputted that a data communication has been conducted among the service blocks, a pop-up window for urging the user to input a communication cost is displayed on the display of the input/output apparatus 102.

FIG. 5 shows a pop-up window for urging an input of a communication cost.

When the user 101 inputs a data using the keyboard of the input/output apparatus 102, the input content is reflected on an input field 503. When a user sets the pointer 502 to click a decision button 504, the input content is displayed in the job flow drawing area 402 as a communication cost value 406 of the data communication arrow mark 405 drawn immediately before the click.

The communication cost does not depend on the communication distance as much as whether that the signal is encrypted or not.

To input a communication cost, it is also possible to use a pop-up window for urging an input of a communication quantity in the pop-up window.

FIG. 6 shows a pop-up window for urging an input of communication quantity.

The user 101 inputs three numerical values of the priority of the communication data, the communication frequency, and the communication data quantity via the keyboard of the input/output apparatus 102 for the job flow input means 104 to decide the communication cost depending on a predetermined calculation rule and to display the result of decision in the job flow drawing area 402, as the communication cost value 406 of the service communication arrow mark 405 drawn immediately before the decision.

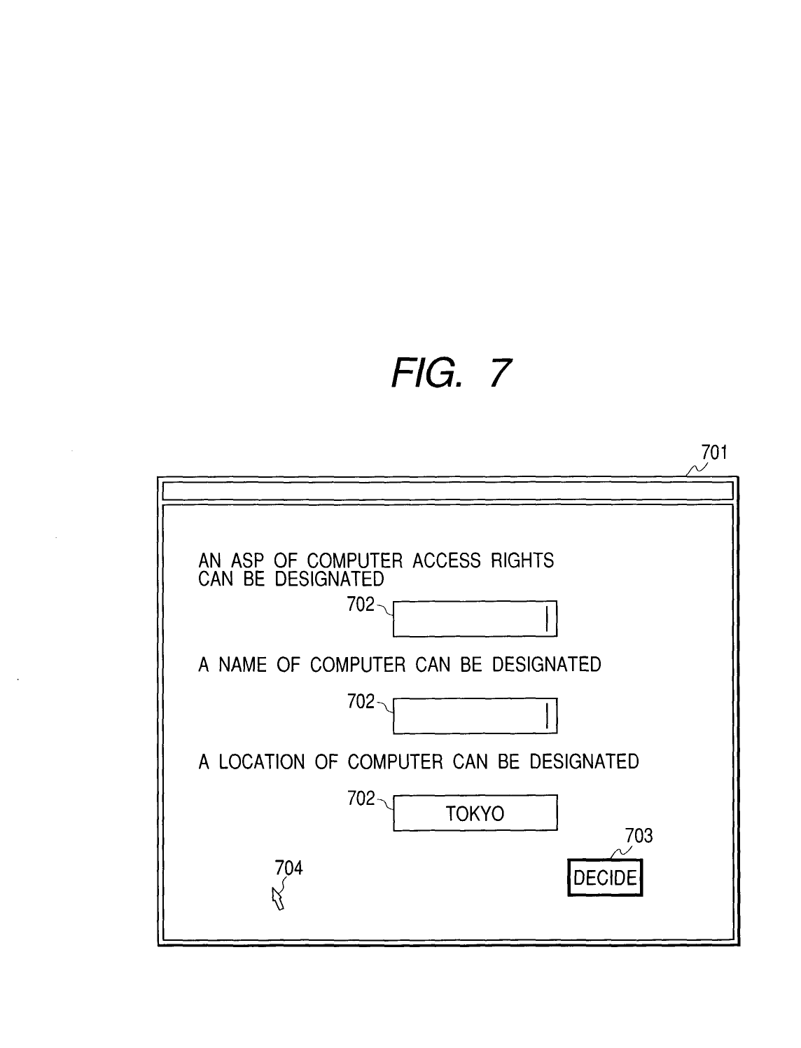

Next, the restriction condition input means 105 is explained with reference to FIG. 7.

The restriction condition input means 105 urges the user 101 to input the restriction condition for selecting the ASP computer access rights for providing the software-based services in the job flow which has been inputted via the job flow input means 104.

As an example for urging input of the restriction condition, a pop-up window (FIG. 7) is displayed on the display of the input/output apparatus 102 when the pointer 409 is set to the service icon 404 in the display image format 401 and the mouse is double-clicked.

In the restriction condition display image format 701 of FIG. 7, inputs of an ASP, a computer name or a computer (or data center) location is urged for the respective input fields 702.

The user 101 can input the restriction condition(s) for selecting the ASP computer access rights to provide the software-based services indicated in the service icons 404 by double-clicking the respective icon and inputting the condition(s) to the input field 702 using the keyboard of the input/output apparatus 102, setting the pointer 704 to the decision button 703 and then clicking the button 703.

For example, an input of “Tokyo” as the computer location limits the access rights of the ASP computers of which location is designated as “Tokyo” in the service function storage means 109 to be selected during the selecting process executed by the computer access right selection means 107.

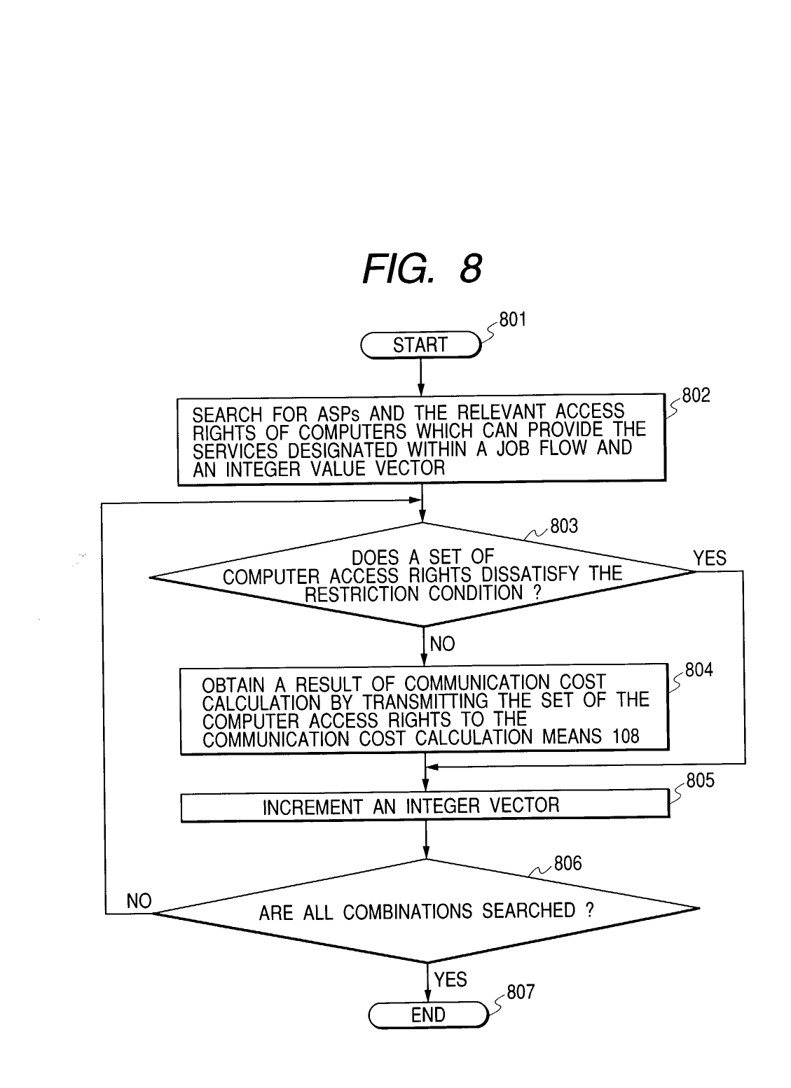

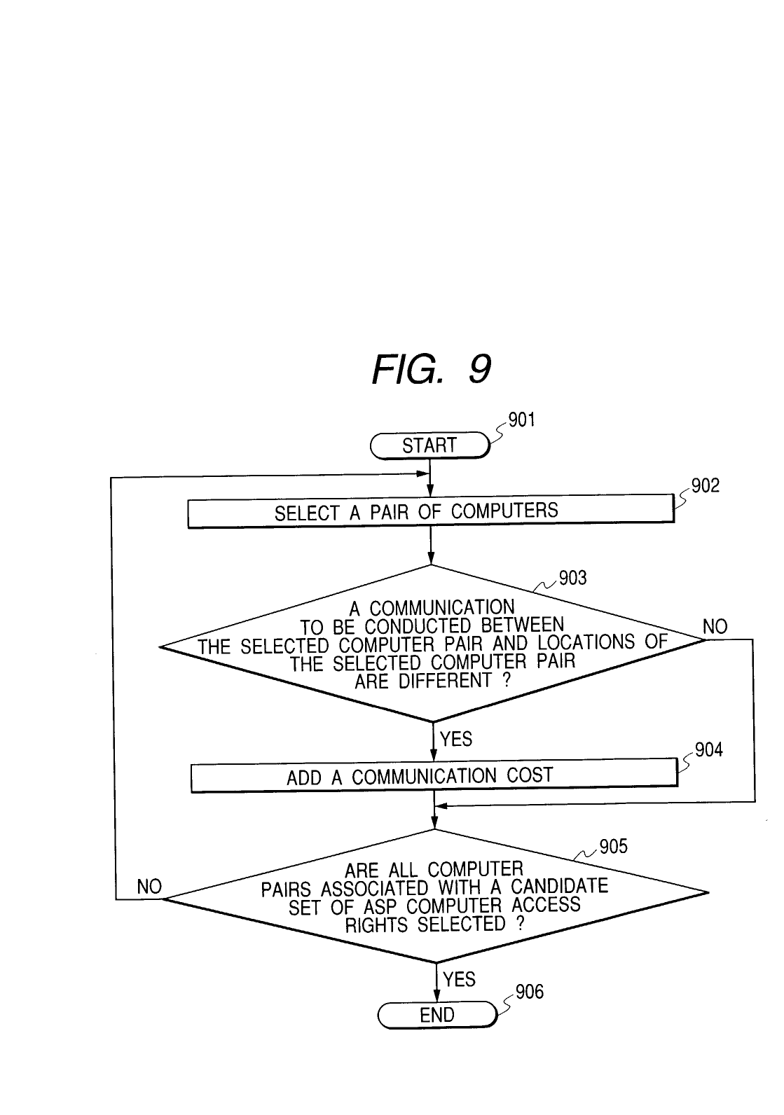

Next, the computer access right selection means 107 is explained with reference to FIG. 8.

The computer access right selection means 107 selects a set ASP computer access rights to provide each service in the job flow inputted with the job flow input means 104 from the registered content of the service function storage means 109.

FIG. 8 is a flowchart showing the operations of the computer access right selection means 107 for selecting a set of ASP computer access rights.

The computer access right selection means 107 starts operations by receiving the job flow inputted with the job flow input means 104.

For the convenience of explanation, it is assumed that k number of service functions are provided within the job flow and the service functions are abbreviated as A₁, A₂, . . . , Aₖ.

In the process 802, the data 301 within the service function storage means 109 is searched for each service function A₁ (1≦i≦K), and the number of ASP computer access rights α₁ (which can execute the service function A₁ with the numbers from 0to α₁−1) to determine the ASP computer access rights.

This operation enables the correspondence on the basis of 1:1 between all combinations of the ASP computer access rights for executing the service functions in the received job flow and aggregating integer value vectors {(a₁, a₂, . . . , aₖ) 0<a₁<α₁, aᵢ is an integer (1≦i≦K)}.

For example, the integer value vector (1,0, . . . ,0) corresponds to a set of the No. 1 ASP computer access rights which can execute the service function A₁ and the No. 0 ASP computer access right which can execute the service functions A₂, . . . , Aₖ.

As the initial value, the integer value vector V=(0, 0, . . . , 0) is used.

In the decision process 803, it is decided, by referring to the data 301 in the service function storage means 109, whether or not a set of the ASP computer access rights for executing the services in the job flow expressed with the integer value vector V conforms to the restriction condition(s) inputted with the restriction condition input means 105.

In the process 804, a set of the ASP computer access rights expressed with the integer value vector V is transmitted to the communication cost calculation means 108.

The process 804 is executed to obtain the result of calculation by the communication cost calculation means 108 and stores a set of the ASP computer access rights and the corresponding communication cost to the storage device.

In the process 805, the integer value vector is incremented by replacing the vector V=(a₁, a₂, . . . , aₖ) with V=(a₁+1, a₂, . . . , aₖ) (a₁=0, aᵢ₊₁=aᵢ₊₁+1 when a₁=α₁).

In the decision process 806, when aₖ is changed to 0 from αₖ−1 in the increment of the process 805, it is decided that all combinations are searched. Thereby, a set of ASP computer access rights and the communication cost stored in the storage device are transmitted to the output means 106 such that the operations of the computer access right selection mans 107 is completed.

In addition, it is possible for the computer selection mans 107 to transmit only a set of the ASP computer access rights to the output means 106 without use of the communication cost calculation means.

Next, the communication cost calculation means 108 is explained with reference to FIG. 9.

The communication cost calculation means 108 calculates a communication cost of a set of ASP computer access rights selected with the computer access right selection means 107 based on the job flow inputted with the job flow input means 104 and the set of the computer access rights selected with the computer access right selection means 107.

FIG. 9 is a flowchart showing operations of the communication cost calculation means 108.

The communication cost calculation means 108 starts operations by receiving a set of the ASP computer access rights from the computer access right selection means 107 and substitute “0” (as the initial condition) for variable C indicating the communication cost.

In the process 902, two computers as a pair are selected based upon the set of the ASP computer access rights received.

In this case, a selected pair of computers are stored such that each computer pair can be selected only once.

In the process 903, the services to be executed with a pair of computers selected in the process 902 are identified from the services of the job flow inputted with the job flow input means 104, and whether or not any data communication has to be conducted among these services is determined.

When it is confirmed that the communication has to be conducted, it is decided in the decision process 903 whether the locations of a pair of computers are different by searching the computer locations registered in the service function storage means 109.

When it is confirmed in the decision process 903 that the communication has to be conducted for a pair of computers selected in the process 902 and locations of the pair of computers are decided to be different, the process 904 is executed. In other cases, the processing goes to the process 905.

In the process 904, the communication cost among the services to be executed with the pair of computers selected in the process 902 is added to the variable C of the communication cost.

When the pair of computers are installed in the same location, the communication cost is assumed to be zero.

In the decision process 905, whether the selection of all computer pairs out of the computers associated with a set of ASP computer access rights have been executed is decided depending on whether the number of times of execution in the decision process 905 is equal to ₖC₂=K!/{(K−1)!2!}.

When it is decided in the decision process 905 that selection of all computer pairs have been executed, the communication cost calculation means 108 transmits the variable C indicating the communication cost to the computer access right selection means 107 as the communication cost of the associated computers with one set of ASP computer access rights received from the computer access right selection means 107 and thereafter completes the operations.

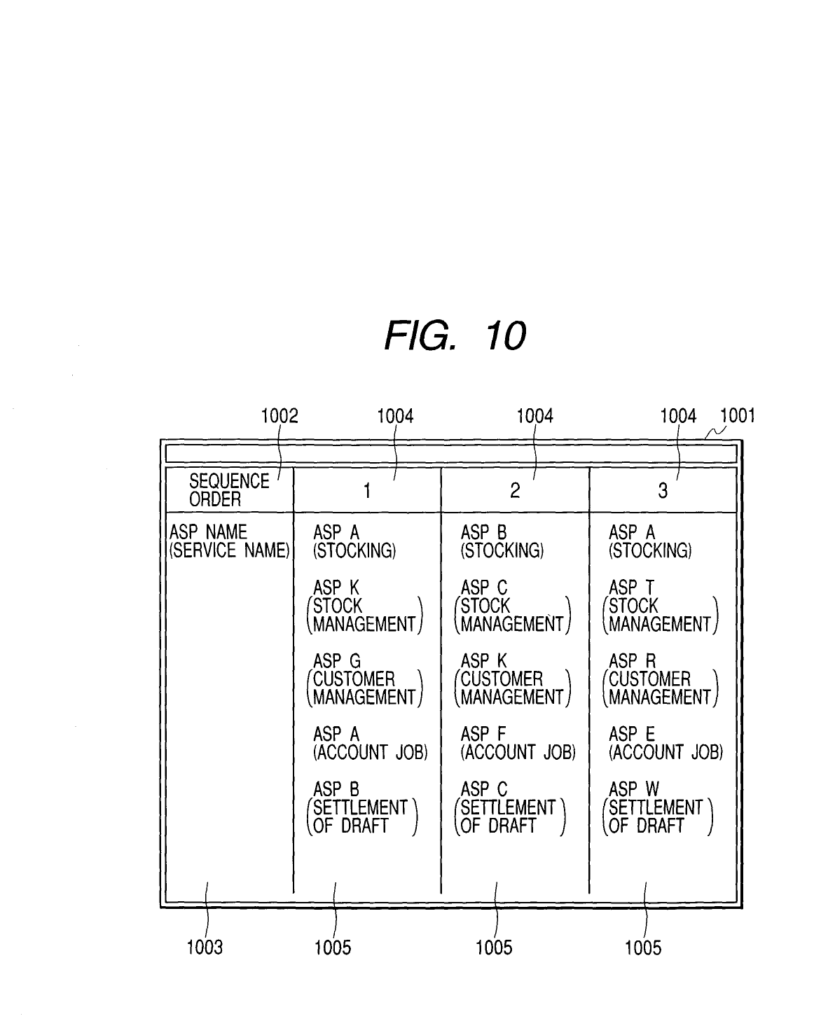

Next, the output means 106 is explained with reference to FIG. 10.

The output means 106 presents a selection result of sets of ASP computer access rights to the user 101 using the input/output apparatus 102 based on the sets of computer access rights received from the computer access right selection means 107 and the relevant communication costs.

FIG. 10 is a table presented by the output means 106 of the selection results of ASP computer access rights to the user 101 by utilizing a display of the input/output apparatus 102.

The output display image format 1001 is composed of a label 1002, a label 1003, a label 1004, and an output data 1005.

The label 1002 and the label 1003 indicate the significance of the rows in the table. The “Sequence Order” of the label 1002 indicates that a numerical value of the label 1004 has the significance of sequence, and the “Name of ASP (Service function)” of the label 1003 indicates that the output data 1005 is composed of the name of a computer access right (ASP) with each service function enclosed by the parentheses.

The label 1004 indicates the significance of columns in the table and the output data 1005 in the column as “1”, i.e., the priority of the output data of the sequence order is 1.

The output means 106 extracts only a set of the computer access rights of the lowest communication cost from the sets of the computer access rights received from the computer access right selection means 107, and it identifies the ASP of the extracted set of the ASP computer access rights and the ASP function from the data area 303 of the service function storage means 109 as well as the job flow to which the service function is inputted with the job flow input means 104. It generates an output content to be displayed as the output data 1005 of the sequence order 1.

In the same manner, the output means 106 extracts another set of the computer access rights of the second lowest communication cost, the set of the computer access rights of the third lowest communication cost from the sets of the computer access rights received from the computer access right selection means 107 thereby generating an output content for displaying the output data 1005 of the sequence order 2 and the output data 1005 of the sequence order 3.

The user 101 can obtain information about an ASP selected by the broker 103 with the output data presented by the output means 106 using the display of the input/output apparatus 102, based on the input of the job flow input means 104 and the restriction condition input means 105.

Moreover, if the computer access right selection means 107 transmits only the set of the computer access rights to the output means 106, the name of the ASP and service function(s) can be outputted to the output data 1005 without setting of the sequence order.

As explained above, according to the present invention, a set of the ASP computer access rights for executing the incorporated software-based services can easily be intermediated for a user who requests the incorporated services with a job flow.

Moreover, a cost-effective set of ASP computer access rights can be intermediated on the basis of the communication cost from the sets of the ASP computer access rights which can execute the incorporated services for a user who requests the incorporated services with a job flow.

In addition, a user can easily input information required for intermediating the ASP computer access rights using the input/output apparatus.

The apparatus or method of the present invention can be implemented by a user, an ASP, or any other third parties, such as an ISP. If the present invention is implemented by a third party to coordinate between the users and the ASPs, the third party may offer one-stop shopping to the users by dealing with the ASPs on behalf of the users such that the users only receive one invoice from the third party for all the software-based services executed by the ASPs, the communication services executed by ISPs, and the coordinating services as well as the intermediation services executed by the third party. As such, the third party has to develop a software to record the above-mentioned services so as to accumulate the charges and to distribute the payment accordingly.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A computer access right intermediation support apparatus, comprising:
service function storage means for storing service functions supported by ASP computers of which access rights are sold and information regarding application service providers (ASPs) for supporting ASP computer access rights;
job flow input means for displaying, on a display apparatus, a job flow requested by a user including a selection of service functions in the job flow from the stored service functions;
ASP computer access right selection means for selecting at least one set of ASP computer access rights from the ASP computer access rights to provide the selected service functions by referring to ASPs and ASP computers associated with the selected set of ASP computer access rights; and
output means for outputting the ASPs and the ASP computers associated with the selected set of ASP computer access rights.

2. A computer access right intermediation support apparatus according to claim 1, wherein the service function storage means stores the service functions to be executed, the ASPs and the ASP computers associated with the selected set of ASP computer access rights, and locations of the associated ASP computers.

3. A computer access right intermediation support apparatus according to claim 1, wherein the user inputs the service functions in the job flow and a communication cost for communicating the service functions and data among the associated ASP computers.

4. A computer access right intermediation support apparatus according to claim 1, further comprising:
restriction condition input means for screening the selected ASP computer access rights with at least one restriction condition input by the user.

5. A computer access right intermediation support apparatus according to claim 3, further comprising:
communication cost calculation means for calculating the communication cost of the selected set of ASP computer access rights selected by the ASP computer access right selection means,
wherein the ASP computer access right selection means selected a set of ASP computer access rights with the minimum communication cost.

6. A method for intermediating ASP computer access rights between at least one user and a plurality of application service providers (ASPs) which support ASP computer access rights, comprising:
collecting and storing in a database service functions supported by the ASPS, ASP computers for executing the service functions, and locations of the ASP computers;
receiving a job flow requested by the user which includes included service functions;
searching the database to obtain a list of ASPs which support said at least one of the service functions in conjunction with ASP computers and ASP computer locations associated with said included service functions so as to compile candidate sets of ASP computer access rights for executing said included service functions in the job flow;
calculating one corresponding communication cost for each of the candidate sets of ASP computer access rights;
sorting the candidate sets of ASP computer access rights based upon the corresponding communication cost in a descending order; and
providing the sorted results to the user to decide which one of the candidate sets of ASP computer access rights to use.

7. The method for intermediating ASP computer access rights according to claim 6, wherein the calculating step involves selecting any pair of ASP computers associated with said each candidate set of ASP computer access rights to repeat for each pair of ASP computers steps of:
determining whether a communication is to be conducted between the pair of ASP computers to support said included service functions in the job flow;
determining whether the locations of the pair of ASP computers are the same, if the communication is determined to be conducted therebetween;
calculating a communication cost between the pair of ASP computers if the pair of ASP computers is determined as being located at two different locations, or assigning the communication cost between the pair of ASP computers as zero if the pair of ASP computers is determined as being located at a same location; and
adding the communication cost between the pair of ASP computers or the zero into the corresponding communication cost for each of the candidate sets of ASP computer access rights.

8. The method for intermediating ASP computer access rights according to claim 7, wherein the communication cost between the pair of ASP computers depends on data quantity, data transmission frequency, and data transmission priority.

9. The method for intermediating ASP computer access rights according to claim 8, wherein the data quantity, the data transmission frequency, the data transmission priority are determined by the user.

10. The method for intermediating ASP computer access rights according to claim 6, further comprising a step of screening the candidate sets of ASP computer access rights with at least one restriction condition regarding at least one of the list of ASPs, the associated ASP computers, and the associated ASP computer locations.

11. The method for intermediating ASP computer access rights according to claim 10, wherein the restriction condition is determined by the user.

12. The method for intermediating ASP computer access rights according to claim 6, further comprising at least one of:
displaying said included service functions in the job flow in service function boxes.
displaying at least one box for soliciting the user to enter the restriction condition.
displaying at least three boxes for soliciting the user to enter a data quantity, a data transmission frequency, and a data transmission priority for calculating the corresponding communication cost for each of the candidate sets of ASP computer access rights.

13. The method for intermediating ASP computer access rights according to claim 12, further comprising a step of connecting said service function boxes with arrows to indicate data communication therebetween for executing the job flow.

14. The method for intermediating ASP computer access rights according to claim 12, wherein a display image format for inputting the corresponding communication cost includes a communication quantity input area, a communication frequency input area, and a communication data priority input area.

15. The method for intermediating ASP computer access rights according to claim 6, wherein the calculating step involves determining the corresponding communication cost by conducting a predetermined arithmetic operation on values of communication data quantity, communication data frequency, and communication data priority which are inputted by the user.

16. The method for intermediating ASP computer access rights according to claim 6, wherein the method is implemented by the user, one of the ASPs, or a third party.

17. The method for intermediating ASP computer access rights according to claim 6, wherein the third party is an internet service provider (ISP).

18. The method for intermediating ASP computer access rights according to claim 9, wherein the method is implemented by a third part to intermediate the ASP computer access rights between the user and the ASPs.

19. The method for intermediating ASP computer access rights according to claim 18, further comprising:
executing the job flow according to the user-selected set of ASP computer access rights;
collecting a charge from the user based upon the corresponding communication cost of the executed set of ASP computer access rights charged by any ISPs transmitting data according to the job flow;
distributing the collected charge to the ASPs, the TSPs, and the third party.

20. An apparatus for intermediating ASP computer access rights between at least one user and a plurality of application service providers (ASPs) which support ASP computer access rights, comprising a controller for:
collecting and storing in a database service functions supported by the ASPs, ASP computers for executing the service functions, and locations of the ASP computers;
receiving a job flow requested by the user which includes at least one of the service functions;
searching the database to obtain a list of ASPs which support said included service functions in conjunction with ASP computers and ASP computer locations associated with said included service functions so as to compile candidate sets of ASP computer access rights for executing said included service functions in the job flow;
calculating one corresponding communication cost for each of the candidate sets of ASP computer access rights;
sorting the candidate sets of ASP computer access rights based upon the corresponding communication cost in a descending order; and
providing the sorted results to the user to decide which one of the candidate sets of ASP computer access rights to use.
